(19) United States
(12) Patent Application Publication
(10) Pub. No.: US 2024/0027703 A1
(43) Pub. Date: Jan. 25, 2024

(54) DEMOUNTABLE CONNECTION OF AN OPTICAL CONNECTOR USING A FOUNDATION HAVING FEATURES FOR INTEGRATED OPTICAL COUPLING AND DEMOUNTABLE MECHANICAL COUPLING

(71) Applicant: Senko Advanced Components, Inc., Hudson, MA (US)

(72) Inventors: Yang CHEN, Thousand Oaks, CA (US); Robert Ryan VALLANCE, Newbury Park, CA (US)

(21) Appl. No.: 18/350,745

(22) Filed: Jul. 11, 2023

Related U.S. Application Data
(60) Provisional application No. 63/388,238, filed on Jul. 11, 2022.
(60) Provisional application No. 63/406,627, filed on Sep. 14, 2022.
(60) Provisional application No. 63/417,988, filed on Oct. 20, 2022.
(60) Provisional application No. 63/512,011, filed on Jul. 5, 2023.

(51) Int. Cl. G02B 6/42

(52) U.S. Cl. CPC G02B 6/4228; G02B 6/4214

(57) ABSTRACT

A demountable connection of an optical connector using a foundation having features for integrated optical coupling and demountable coupling. The foundation provides for demountable passive alignment connection to an optical connector. The foundation is permanently attached and aligned to a PIC chip. The foundation includes optical elements that redirect and reshape incident light to follow a desired light beam shape and path between the optical connector and the optoelectronic device. The foundation may include a combination of different optical elements having optical properties that produces the desired light beam quality and direction. The foundation also includes passive alignment features that matches the passive alignment features on the facing side of the optical connector. The foundation has a unitary, monolithic body that is provided with the optical elements and the passive alignment features.

### PRIORITY CLAIM

This application claims the priorities of (a) U.S. Provisional Patent Application No. 63/388,238 filed on Jul. 11, 2022; (b) U.S. Provisional Patent Application No. 63/406,627 filed on Sep. 14, 2022; (c) U.S. Provisional Patent Application No. 63/417,988 filed on Oct. 20, 2022; and (d) U.S. Provisional Patent Application No. 63/512,011 filed on Jul. 5, 2023. These applications are fully incorporated by reference as if fully set forth herein. All publications noted below are fully incorporated by reference as if fully set forth herein.

### BACKGROUND OF THE INVENTION

### Field of the Invention

The present invention relates to coupling of light into and out of optoelectronic components (e.g., photonic integrated circuits (PICs)), and more particular to the optical connection of optical fibers to PICs.

### Description of Related Art

Photonic integrated circuits (PICs) or integrated optical circuits are part of an emerging technology that uses light as a basis of operation as opposed to an electric current. A PIC device integrates multiple (at least two) photonic functions and as such is analogous to an electronic integrated circuit. The major difference between the two is that a photonic integrated circuit provides functionality for information signals imposed on optical wavelengths typically in the visible spectrum or near infrared 850 nm-1650 nm.

PICs are used for various applications in telecommunications, instrumentation, and signal-processing fields. A PIC device (in the form of a photonic chip package) typically uses optical waveguides to implement and/or interconnect various on-chip elements, such as waveguides, optical switches, couplers, routers, splitters, multiplexers/demultiplexers, modulators, amplifiers, wavelength converters, optical-to-electrical (O/E) and electrical-to-optical (E/O) signal converters (e.g., photodiodes, lasers), etc. A waveguide in a PIC device is usually an on-chip solid light conductor that guides light due to an index-of-refraction contrast between the waveguide's core and cladding.

One of the most expensive components within photonic networks are the fiber-optic connectors. For proper operation, a PIC typically needs to efficiently couple light between an external optical fiber and one or more of on-chip waveguides. It is often necessary for PIC devices to have optical connections to other PIC devices, often in the form an organized network of optical signal communication. The connection distances may range from a several millimeters in the case of chip-to-chip communications up to many kilometers in case of long-reach applications. Optical fibers can provide an effective connection method since the light can flow within the optical fibers at very high data rates (>25 Gbps) over long distances due to low-loss optical fibers. For proper operation, a PIC device needs to efficiently couple light between an external optical fiber and one or more on-chip waveguides. An advantage of using light as a basis of circuit operation in a PIC device is that its energy cost for high-speed signal transmission is substantially less than that of electronic chips. Thus, efficient coupling between PIC devices and other optical devices, such as optical fibers, that maintains this advantage is an important aspect of PICs.

One approach to coupling optical fibers to a PIC device (or a PIC chip package) is to attach an optical fiber array to the edge of the PIC chip. Heretofore, optical fiber arrays are aligned to elements on the PICs using an active alignment approach in which the position and orientation of the optical fiber(s) is adjusted by machinery until the amount of light transferred between the fiber and PIC is maximized. This is a time-consuming process that is generally done after the PIC is diced from the wafer and mounted within a package. This postpones the fiber-optic connection to the end of the production process. Once the connection is made, it is permanent, and would not be demountable, separable or detachable without likely destroy the integrity of connection for any hope of remounting the optical fiber array to the PIC. In other words, the optical fiber array is not removably attachable to the PIC, and the fiber array connection, and separation would be destructive and not reversible (i.e., not reconnectable).

The current state-of-the-art attempts are to achieve stringent alignment tolerances using polymer connector components, but polymers have several fundamental disadvantages. First, they are elastically compliant so that they deform easily under external applied loads. Second, they are not dimensionally stable and can change size and shape especially when subjected to elevated temperatures such as those found in computing and networking hardware. Third, the coefficient of thermal expansion (CTE) of polymers is much larger than the CTE of materials that are commonly used in PIC devices. Therefore, temperature cycles cause misalignment between the optical fibers and the optical elements on the PIC devices. In some cases, the polymers cannot withstand the processing temperatures used while soldering PIC devices onto printed circuit boards.

In addition, it would be advantageous if the fiber-optic connections could be created prior to dicing the discrete PIC devices from the wafer; this is often referred to as wafer-level attachment. Manufacturers of integrated circuits and PICs often have expensive capital equipment capable of sub-micron alignment (e.g., wafer probers and handlers for testing integrated circuits), whereas companies that package chips generally have less capable machinery (typically several micron alignment tolerances which is not adequate for single-mode devices) and often use manual operations. However, it is impractical to permanently attach optical fibers to PICs prior to dicing since the optical fibers would become tangled, would be in the way during the dicing operations and packaging procedures, and are practically impossible to manage when the PICs are pick-and-placed onto printed circuit boards and then soldered to the PCBs at high temperatures.

A further design challenge is to improve optical and mechanical compatibility of optical connectors to PIC devices without an elaborate or complex connector assembly to implement a robust optical connection. In general, a PIC device is packaged in a structure which structural integrity could be compromised if structural changes are made to the package to accommodate mechanical coupling of an optical connector. Furthermore, dicing of PIC devices from a wafer does not provide a good datum for optical and physical alignments of optical connectors to PIC devices. Without modifications to the PIC device, often an elaborate foundation is provided around the PIC device to facilitate mechanical and optical coupling by an optical connector. This would increase bulk to the overall structure. Furthermore, PIC devices have different optical input/output configurations, which would require optical connectors to be designed to be compatible with the optical input/output configurations of the PIC devices.

US Patent Publication No. 2016/0161686A1 (commonly assigned to the assignee of the present application, and fully incorporated by reference herein) discloses demountable optical connectors for optoelectronic devices. The disclosed demountable optical connectors include implementation of an elastic averaging coupling to provide an improved approach to optically couple input/output of optical fibers to PICs which improves tolerance, manufacturability, ease of use, functionality and reliability at reduced costs. As is known in the prior art, elastic averaging represents a subset of surface coupling types where improved accuracy is derived from the averaging of error over a large number of contacting surfaces. Contrary to kinematic design, elastic averaging is based on significantly over-constraining the solid bodies with a large number of relatively compliant members. As the system is preloaded, the elastic properties of the material allow for the size and position error of each individual contact feature to be averaged out over the sum of contact features throughout the solid body. Although the repeatability and accuracy obtained through elastic averaging may not be as high as in deterministic systems, elastic averaging design allows for higher stiffness and lower local stress when compared to kinematic couplings. In a well-designed and preloaded elastic averaging coupling, the repeatability is approximately inversely proportional to the square root of the number of contact points.

Most PIC devices require single-mode optical connections that require stringent alignment tolerances between optical fibers and the PIC, typically less than 1 micrometer. Efficient optical coupling to and from the on-chip single-mode waveguides to an external optical fiber is challenging due to the mismatch in size between the single-mode waveguides and the light-guiding cores within optical fibers. For example, the dimension of a typical silica optical fiber is approximately forty times larger than a typical waveguide on a PIC. Because of this size mismatch, if the single mode waveguide and the optical fiber are directly coupled, the respective modes of the waveguide and optical fiber may not couple efficiently resulting in an unacceptable insertion loss (e.g., >20 dB).

U.S. Pat. No. 11,022,755 (commonly assigned to the assignee of the present application, and fully incorporated by reference herein) discloses demountable edge couplers with micro-mirror optical bench for PICs, which provide a mechanism to bring the mode sizes of the optical fibers in a fiber array and on-chip optical elements close to each other to effectuate efficient optical coupling input/output of optical fibers to PIC devices.

What is needed is an improved demountable optical and mechanical coupling for connecting optical connectors to PIC devices, which improves flexibility, tolerance, manufacturability, ease of use, functionality and reliability at reduced costs.

### SUMMARY OF THE INVENTION

The present invention overcomes the drawbacks of the prior art by providing a foundation in the form of an adaptor to provide a bridge for demountable/separable and reconnectable passive alignment coupling/connection that achieves high alignment accuracy. An optical connector (e.g., supporting or is a part of an optical bench that supports an optical fiber) is configured and structured to be non-destructively, removably attachable for reconnection to the foundation in alignment therewith. The foundation may be an integral part of the opto-electronic device (e.g., part of a photonic integrated circuit (PIC) chip), or a separate component attached to or in association with and/or in optical alignment reference to the opto-electronic device.

The present invention will be explained in connection with the illustrated embodiments. The foundation can be aligned to electro-optical elements (e.g., grating couplers, waveguides, etc.) in the optoelectronic device. The foundation is permanently positioned with respect to the opto-electronic device to provide an alignment reference to the external optical connector. The optical connector can be removably attached to the foundation, via a ‘separable’ or ‘demountable’ or ‘detachable’ action that accurately optically aligns the optical components/elements in the optical connector to the opto-electronic device along a desired optical path. In order to maintain optical alignment for each connect and disconnect and reconnect, this connector needs to be precisely and accurately aligned to the foundation. In accordance with the present invention, the connector and foundation are aligned with one another using a passive mechanical alignment (e.g., kinematic, quasi-kinematic, and elastic-averaging alignment), constructed from geometric features on the two bodies. The present invention will be discussed more specifically in reference to mechanical alignment based on elastic-averaging alignment. With the foregoing as introduction, the present invention may be summarized below.

In one aspect of the present invention, the foundation includes one or more optical elements, which may include a diffractive optical element, a lens, a prism, a reflective surface that may reflect light by total internal reflection (TIR) of an opaque free surface exposed to the exterior (e.g., air or an index matching material), and reflecting incident light directed at the free surface from the exterior side (i.e., the incident light is not directed through the body of the foundation), or any other optical features and elements that effectively redirect (i.e., reflects. folds, turns, reroute, reshape (e.g., focusing, collimating, diverging, converging, or splitting)) incident light from the optical connector and/or the optoelectronic device. The optical element(s) of the foundation redirect and/or reshape incident light to follow a desired light beam path between the optical connector and the optoelectronic device (i.e., matching the optical axes of the optical connector and the optoelectronic device). The foundation may include a combination of different optical elements having optical properties that produces the desired light beam quality and direction. In addition, the foundation includes passive alignment features, such as kinematic, quasi-kinematic and elastic averaging alignment features, which matches/complements the passive alignment features on the facing side of the optical connector. In one embodiment, the foundation comprises a unitary, monolithic body that is provided with the optical elements and the passive alignment features. In another embodiment, the foundation may include separate bodies, which are separately provided with passive alignment features and optical element(s).

In one embodiment, the foundation is a longitudinal glass substrate or plate having passive alignment features integrally formed on the top surface of the foundation body (i.e., the surface facing the optical connector to be attached to the foundation). In a further embodiment, the foundation in addition includes passive alignment features integrally formed on the bottom surface of the foundation body that faces the optoelectronic device. The passive alignment features are grouped in two sets, with each set near the opposite ends on the surface(s) of the longitudinal plate. Between the passive alignment features, an array of optical elements (e.g., microlenses) is integrally formed on the foundation (i.e., not separate lenses disposed on the surface). The passive alignment features and the array of optical element may be integrally defined on the foundation body with geometries and relative positions defined in a final forming step, so as to accurately define the alignment relationship of the passive alignment features relative to the array of optical elements. For example, in the case of a foundation body made of glass, the passive alignment features and the array of optical elements may be molded to define the final geometries and locations of the array of optical elements and passive alignment features.

In the case where the foundation does not have passive alignment features at its bottom surface, the foundation may be optically aligned with a supporting surface and fixedly attached to the supporting surface (e.g., the top surface of a PIC device, or grating coupler and/or waveguides on a support on a submount on a circuit board which optically communicates with a PIC device). The foundation may be visually aligned to the supporting surface using visual fiducials defined on the supporting surface, or in addition or alternatively optically aligned by determining an optical signal from a loop-back optical channel on the supporting surface corresponding to a desired position of the foundation relative to the supporting surface. Once the foundation is optically aligned to the supporting surface, the foundation is fixedly attached to the supporting surface (e.g., by epoxy or solder). The foundation thereby provides a demountable connection for an optical connector with matching passive alignment features on its facing mounting surface onto the supporting surface. In the case where the foundation has in addition passive alignment features at its bottom surface, and the supporting surface has matching passive alignment features, the foundation may be passively aligned and fixedly attached to the supporting surface.

In another embodiment, the optical connector may be first coupled to the foundation. The optical connector is actively aligned to the optoelectronic device by positioning the foundation relative to the optoelectronic device (e.g., a PIC chip or an optical I/O chip) to obtain an optimum optical signal between the optoelectronic device and the optical connector (e.g., optical fibers supported by the optical connector). The location of the foundation is secured with respect to the optoelectronic device at the aligned position (e.g., using a solder to tack the position of the foundation on a support for the optoelectronic device, such as an interposer, a printed circuit board, a submount, etc.). The optical connector is then demounted from the foundation, and the foundation can be permanently attached to the support (e.g., reflowing the solder) without changing its position on the support. Thereafter, the optical connector can be repeatedly connected and disconnected and reconnected to the foundation non-destructively without losing the original optical alignment obtained by active alignment between the optical connector and the optoelectronic device. Optical alignment in accordance with original active alignment is maintained for each connect and disconnect and reconnect, to precisely and accurately align the optical connector to the foundation.

In one embodiment, the foundation comprises a unitary, monolithic body that is provided with optical elements and passive alignment features. In another embodiment, the foundation may include separate bodies, which are separately provided with passive alignment features and optical element(s).

In another embodiment, the foundation may be in the form of a silicon insert, which has an optically transparent body. The silicon insert can be integrally defined (e.g., by etching) with passive alignment features and an array of optical elements to facilitate direct connection to the top of a PIC device or a grating coupler on a supporting surface. If a window is provided on the cooling plate above the PIC device, this window can be used to design an optical connector body to provide rough alignment to guide the connection body to achieve demountable connection based on the passive alignment features.

In another aspect of the present invention, the foundation could be configured for demountable edge coupling of an optical connector to the waveguides ending at an edge of the optoelectronic device. The foundation may be configured with different optical elements to define the desire beam path with the desired beam shape to maximize optical coupling of optical signals into/out of the optoelectronic device and into/out of the optical connector. For example, the optical beam may be initially expanded between the optical connector and the optoelectronic device and finally focused onto the waveguides on the optoelectronic device and the optical connector. Transmission of the expanded beam requires lower tolerance, with high tolerance maintained at the point of focusing the beam at the target device.

In a further embodiment, a foundation is in the form of an interposer for guiding light to/from the exit ends of an array of waveguides at a top or bottom surface of an optoelectronic device (e.g., a SiPIC). The interposer includes an array of optical elements for guiding light from the optical connector and prongs on both sides of the array of optical elements, extending outwards over the surface of the optoelectronic device. The prongs are integrally formed with passive alignment features for passive alignment with the passive alignment features defined on the surface of the optoelectronic device, thereby optically aligning the array of optical elements to the array of waveguides.

In a further embodiment, the foundation in each of the above discussed embodiments may be an integral part of the optoelectronic device or the support for the optoelectronic device.

With the foregoing as introduction, the present invention may be further discussed below to support the features recited in the claims.

### BRIEF DESCRIPTION OF THE DRAWINGS

For a fuller understanding of the nature and advantages of the invention, as well as the preferred mode of use, reference should be made to the following detailed description read in conjunction with the accompanying drawings. In the following drawings, like reference numerals designate like or similar parts throughout the drawings.

FIG. 1A illustrates an adaptor/foundation having passive alignment features, in accordance with one embodiment of the present invention; FIG. 1B illustrates an adaptor/foundation having passive alignment features, in accordance with another embodiment of the present invention.

FIGS. 2A and 2B schematically illustrate a process of molding a glass adaptor/foundation, in accordance with one embodiment of the present invention.

FIGS. 3A to 3E illustrate aligning a glass foundation to a PIC device, in accordance with one embodiment of the present invention.

FIGS. 4A to 4C illustrate demountable connection of an optical connector to the glass foundation, in accordance with one embodiment of the present invention.

FIG. 5 illustrates passive alignment of a glass foundation to a PIC device, in accordance with another embodiment of the present invention.

FIG. 6 illustrates a glass foundation comprising one or more separate pieces, in accordance with another embodiment of the present invention.

FIGS. 7A to 7F illustrate implementation of a silicon lens insert in an optical connector for a glass foundation, in accordance with another embodiment of the present invention; FIG. 7G illustrates implementation of a silicon lens insert in an optical connector for directly coupling to a PIC device.

FIGS. 8A and 8B illustrate alternative application of optical connectors in co-packaged optics.

FIGS. 9A and 9D illustrate implementation of a foundation as an edge coupler to a PIC chip, in accordance with one embodiment of the present invention.

FIGS. 10A and 10B illustrate perspective views of the foundation, in accordance with one embodiment of the present invention; FIGS. 10C and FIGS. 10D illustrate different optical elements (e.g., lens, reflective surface) deployed on the foundation.

FIGS. 11A to 11F illustrate various foundations adopting different optical elements for optical coupling to PIC devices, in accordance with alternate embodiments of the present invention.

FIGS. 12A to 12F illustrate implementation of a foundation as an edge coupler to a PIC chip having waveguides at its top surface, in accordance with another embodiment of the present invention.

FIGS. 13A to 13D illustrate implementation of a foundation as an edge coupler to a PIC chip having waveguides at its bottom surface, in accordance with another embodiment of the present invention.

### DETAILED DESCRIPTION OF THE PREFERRED EMBODIMENTS

This invention is described below in reference to various embodiments with reference to the figures. While this invention is described in terms of the best mode for achieving this invention's objectives, it will be appreciated by those skilled in the art that variations may be accomplished in view of these teachings without deviating from the spirit or scope of the invention.

The present invention overcomes the drawbacks of the prior art by providing a foundation in the form of an adaptor to provide a bridge for demountable/separable and reconnectable passive alignment coupling/connection that achieves high alignment accuracy. An optical connector (e.g., supporting or is a part of an optical bench that supports an optical fiber) is configured and structured to be non-destructively, removably attachable for reconnection to the foundation in alignment therewith.

The foundation may be an integral part of the opto-electronic device (e.g., part of a photonic integrated circuit (PIC) chip), or a separate component attached to or in association with and/or in optical alignment reference to the opto-electronic device. The passive alignment coupling concept of the present invention is discussed hereinbelow by reference to the example of a PIC device as an optoelectronic device and an optical connector comprising an optical bench, and optically coupling an input/output end of an optical component (e.g., an optical fiber) supported in the optical bench with the optoelectronic device. The present invention may be applied to provide removable/reconnectable form structures and parts used in other fields.

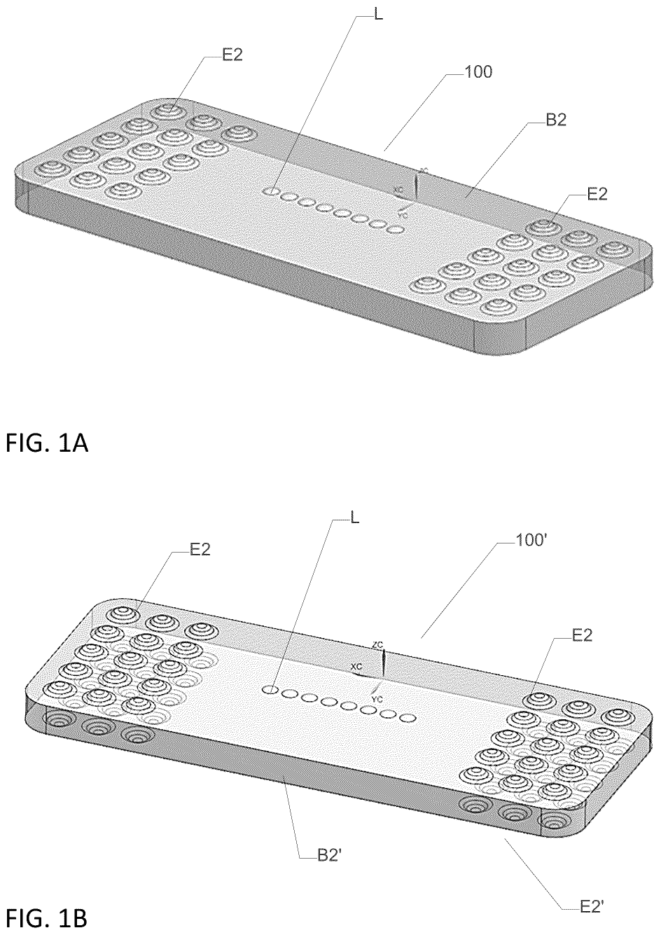

FIG. 1A illustrates a foundation 100 acting as an adaptor, or interposer, or insert, which has passive alignment features defined on its top surface, in accordance with a simple embodiment of the present invention to illustrate the inventive concept.

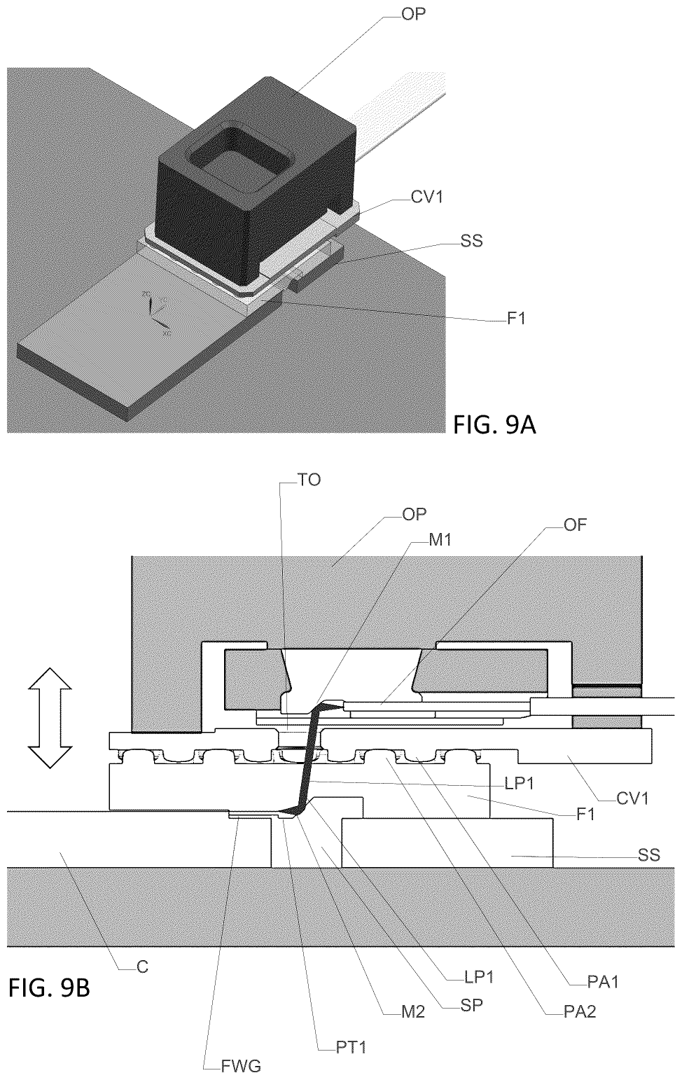

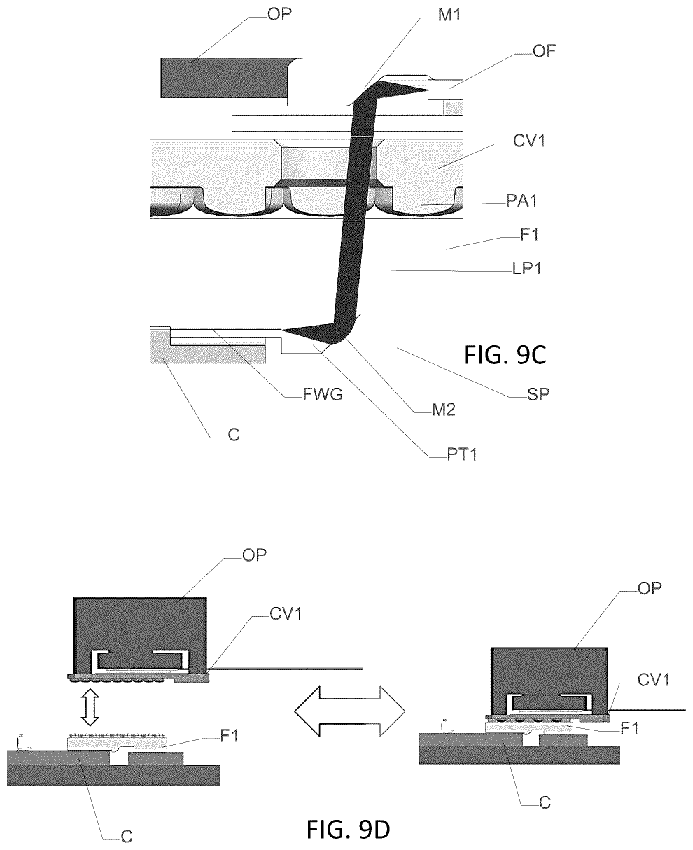

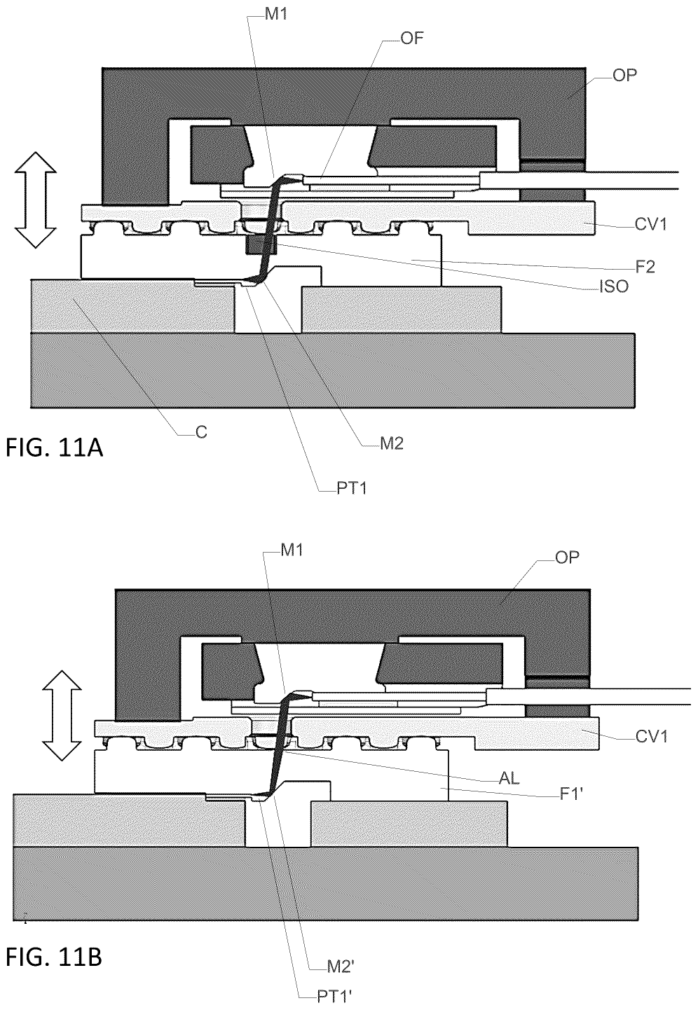

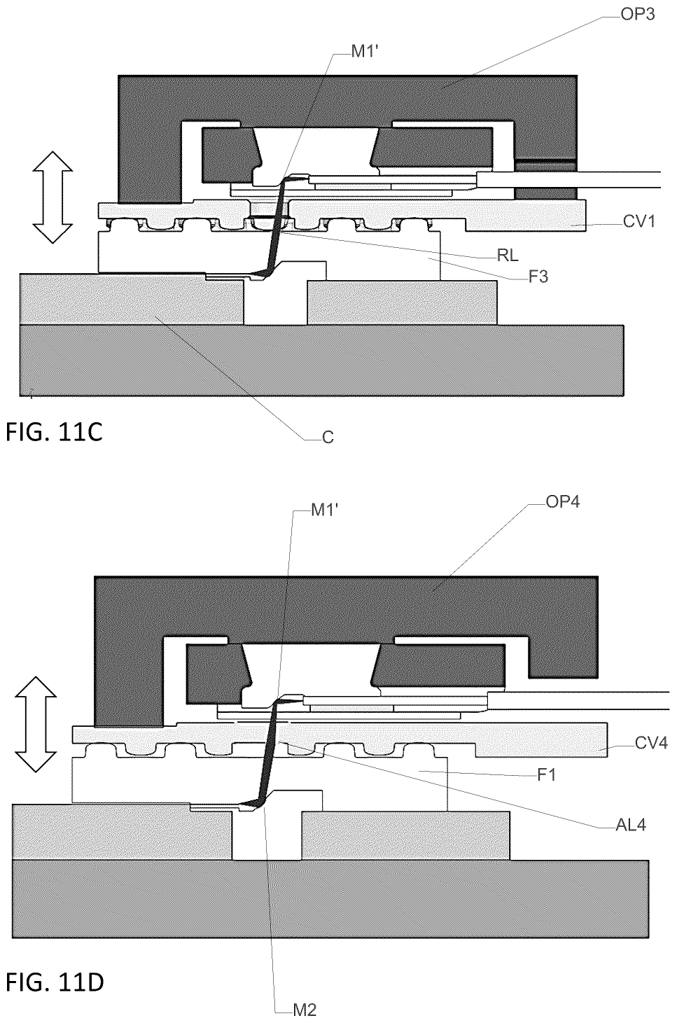

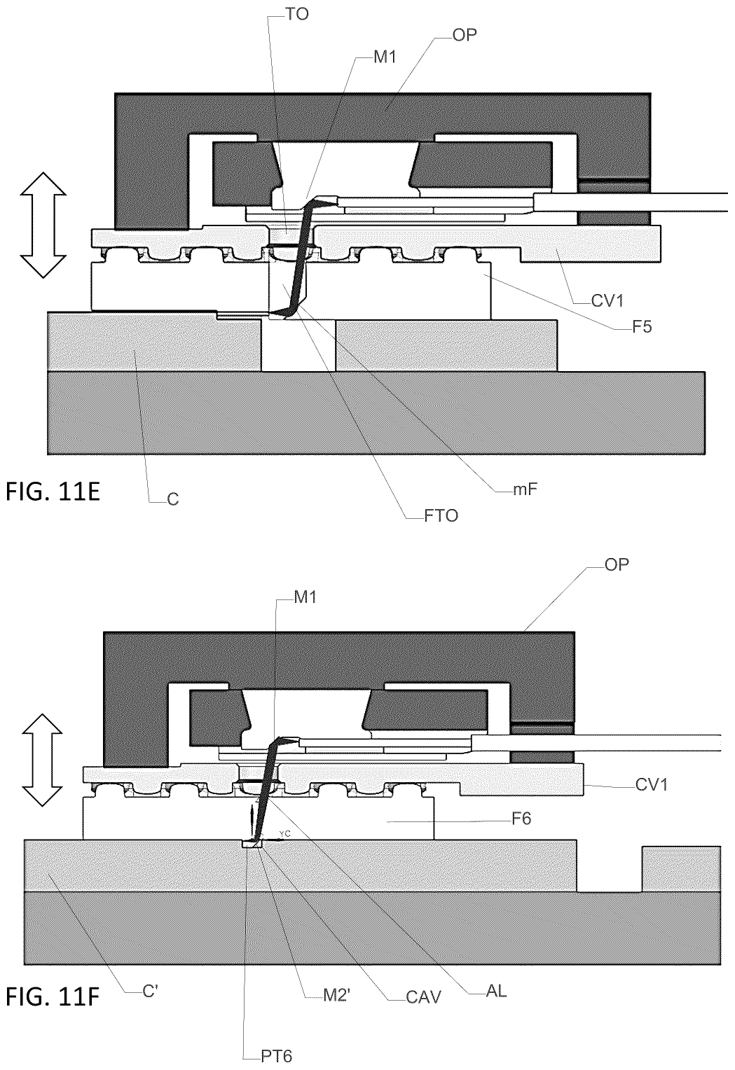

In one aspect of the present invention, the foundation 100 includes one or more optical elements. In the illustrated embodiment, the optical elements are in form of a microlens array L. In further embodiments discussed below (see, e.g., FIGS. 9A to 9D and 11A to 11F), additional and/or different optical elements are formed in the foundation to reshape and reflect incident light by total internal reflection (TIR) of an opaque free surface exposed to the exterior (e.g., air or an index matching material), and reflecting incident light directed at the free surface from the exterior side (i.e., the incident light is not directed through the body of the foundation). The optical element(s) of the foundation 100 redirect and/or reshape incident light to follow a desired light beam path between the optical connector and the PIC chip P (i.e., matching the optical axes of the optical connector 10 to that of the PIC chip P).

In addition, the foundation 100 includes passive alignment features E2, such as kinematic, quasi-kinematic and elastic averaging alignment features, which matches/complements the passive alignment features E1 on the facing side of the optical connector 10. In the illustrated embodiment, the passive alignment features are based on surface features for elastic averaging connection. US Patent Publication No. 2016/0161686A1 and U.S. Pat. No. 11,500,166B2 discloses elastic averaging features suitable for connection of an optical connector to a support foundation.

In the illustrated embodiment, the foundation 100 comprises a unitary, monolithic body B2 that is provided with the mircrolens array L and the passive alignment features E2.

In the illustrated embodiment, the foundation body B2 is a longitudinal glass substrate or plate having passive alignment features E2 integrally formed on the top surface of the foundation body B2 (i.e., the surface facing the optical connector 10 when attached to the foundation). The passive alignment features E2 are grouped in two sets, with each set near the opposite ends on the surface of the longitudinal plate. Between the passive alignment features, a microlens array L is integrally formed on the foundation 10 (i.e., not as separate lens elements disposed on the surface). The passive alignment features E2 and the array of microlens array L may be integrally defined on the foundation body B2 with their geometries and relative positions defined in a final forming step, so as to accurately define the alignment relationship of the passive alignment features E2 relative to the microlens array L. For example, in the illustrated embodiment of a foundation body B2 made of glass, the passive alignment features E2 and the microlens array L may be molded to define the final geometries and locations of the microlens array L and passive alignment features E2. Alignment features E2 and microlens array L produced on same substrate with single tool/mask, minimize position error between these two features.

Glass is a good material for the foundation 100, and the coefficient of thermal expansion (CTE) can match silicon of the PIC chip P (CTE ˜3×10⁻⁶ K⁻¹). Glass molding permits optimized optical design and mechanical design for operating of ˜100° C. Glass can survive solder reflow at temperatures to 280° C.

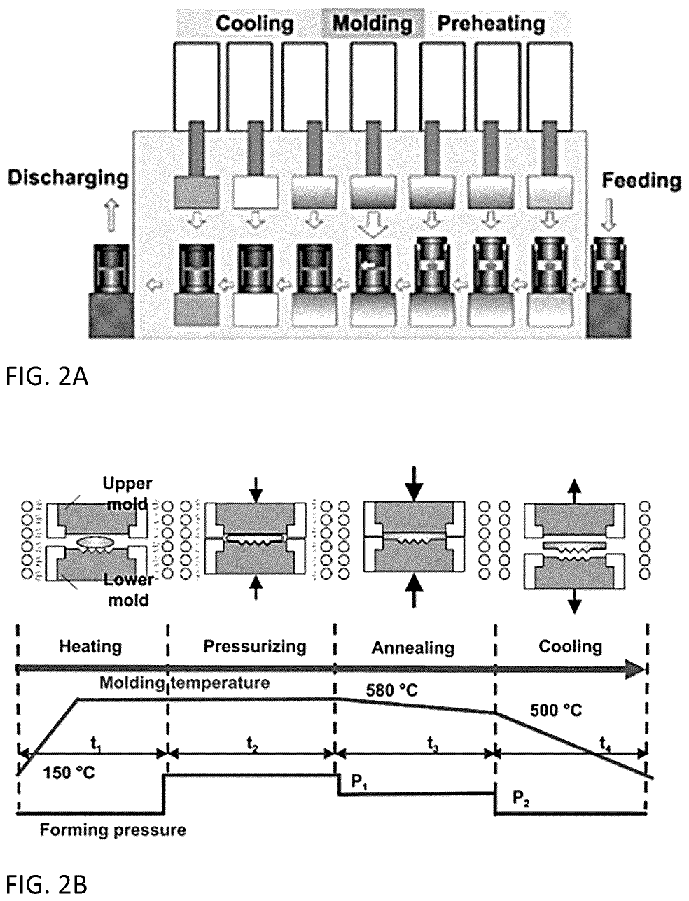

FIGS. 2A and 2B schematically illustrate a glass molding process discussed in the publication by Zhou et al. [“A review of the techniques for the mold manufacturing of micro/nanostructures for precision glass molding”. Intl. Jrnl of Extreme Manufacturing. 3 (2021). 042002], which can be adapted to mold the foundation 100, in accordance with one embodiment of the present invention. FIG. 2A is a schematic depiction of a PFLF7-60A molding machine. FIG. 2B is a diagram depicting the stages of the glass molding process using such molding machine, relating molding temperature and forming pressure at the various stages of the molding process.

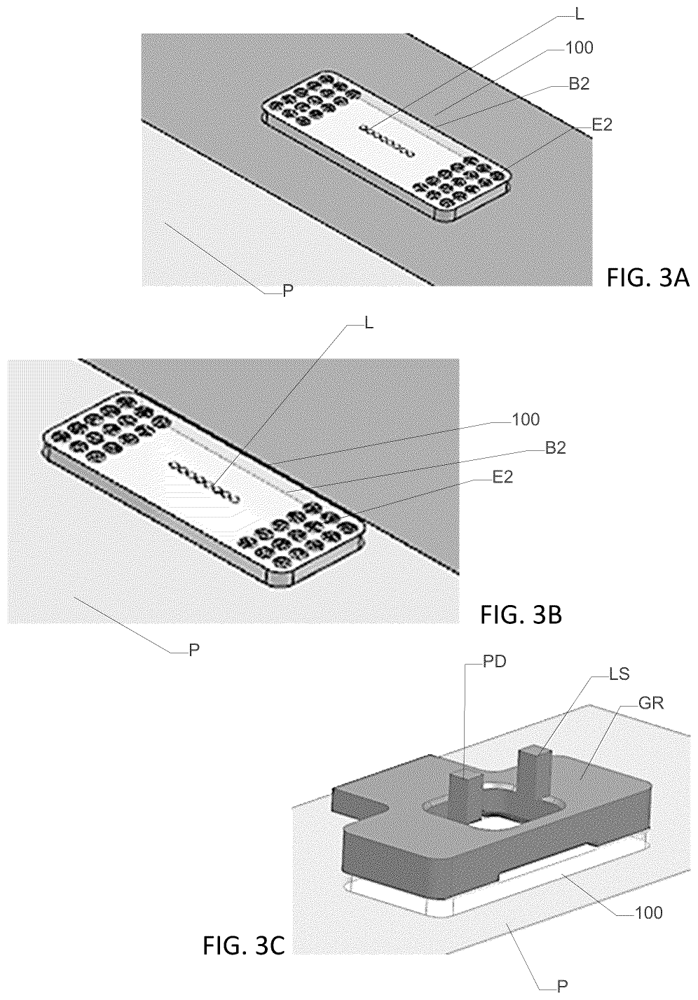

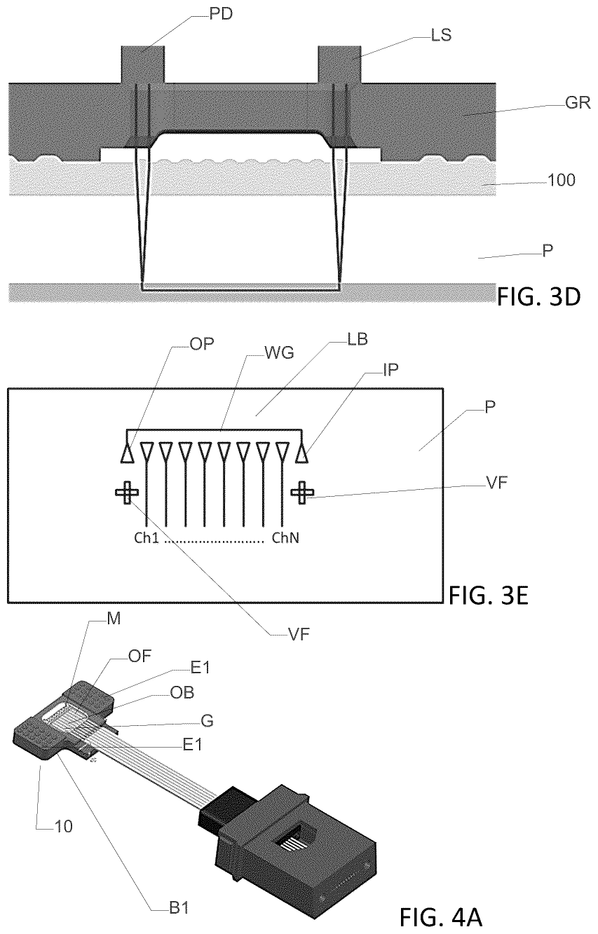

FIGS. 3A and 3B illustrate optically aligning a glass foundation to a PIC device, in accordance with one embodiment of the present invention. In the illustrated embodiment, the foundation 100 may be optically aligned with a supporting surface (e.g., the top surface of the PIC chip P, or grating coupler and/or waveguides on a support on a submount on a circuit board which optically communicates with a PIC chip P) and fixedly attached to the supporting surface. In FIG. 3A, the foundation 100 may be visually aligned to the supporting surface using visual fiducials defined on the supporting surface. In FIG. 3B, once the foundation 100 is optically aligned to the supporting surface, the foundation 100 is fixedly bonded to the supporting surface (e.g., by epoxy or solder). The entire package can go through solder reflow and other packaging processes. The bottom surface of the foundation body B2 could be plated to allow for solder reflow attachment to the PIC chip P.

FIGS. 3C and 3E depicts an alternative or additional optically alignment process for the foundation 100, by determining an optical signal from a loop-back optical channel on the supporting surface corresponding to a desired position of the foundation relative to the supporting surface. Referring to FIG. 3C, a gripper GR, with mechanical passive alignment features similar to the passive alignment features El on the optical connector 10, is used to pick and place the foundation 100 onto the PIC chip P. The foundation 10 is first aligned to the PIC chip P using visual fiducials VF provided on the PIC chip during packaging. This can achieve alignment accuracy of a few micrometers. This enables “first-light” for further more accurate optical alignment. Next, the gripper GR is more accurately aligned using optical alignment. The gripper GR can incorporate a laser light source LS and a photodiode PD. Light is injected into a ‘loop-back’ LB on the PIC chip P (inlet port IP, waveguide WG, outlet port OP). During this optical alignment process, the functional waveguides of channel Ch1 to ChN of the PIC chip P are not used. This optical alignment process may be referenced to the optical passive alignment of an optical connector assembly to an optoelectronic device in the process disclosed in U.S. Pat. No. 9,897,769B2 commonly assigned to the assignee of the present application.

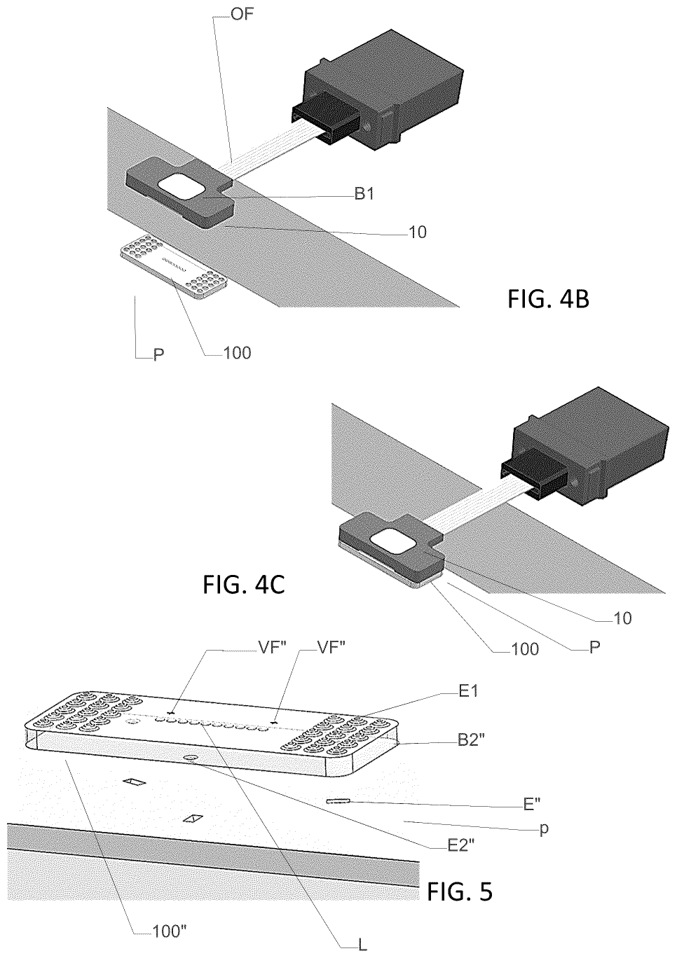

FIGS. 4A to 4C illustrate demountable connection of an optical connector to the glass foundation 100 that has been bonded to the supported surface, in accordance with one embodiment of the present invention. As shown in FIG. 4A, the optical connector 10 includes an array of micromirrors M, which correspond to the array of microlenses L on the foundation 100. The optical connector 10 also accurately supports the exit ends of the optical fibers OF with respect to the micromirror array M, and hence also in reference to the the passive alignment features E1. In the illustrated embodiment, the optical connector 10 comprises a body B1 supporting an array of optical fiber OF transmitting an optical signal. The foundation 100 therefore comprises a body B2 providing an alignment reference to an external optoelectronic device (e.g., a PIC chip P, or an I/O PIC chip for an ASIC chip (e.g., CPU, GPU, switch ASIC) communicating optical signals with optical fiber OF in the optical connector 10.

More specifically, the body B1 of the connector 10 defines a base supporting the optical fiber array OF having a planar surface defined with a two-dimensional planar array of alignment features El integrally defined on the surface of the base of the body B1. In this embodiment, the connector 10 incorporates a micro optical bench OB for supporting and aligning the optical fiber array FA. The optical fiber array has a plurality of optical fibers OF protected by protective buffer and matrix/jacket layers P. The base of body B1 of the connector 10 defines structured features including an alignment structure comprising open grooves G for retaining bare sections of optical fibers OF (having cladding exposed, without protective buffer and matrix/jacket layers J), and structured reflective surfaces (e.g., eight mirrors M). The open grooves G are sized to receive and located to precisely position the end section of the optical fibers OF in alignment with respect to a first array of mirrors M along ant optical path. The end face (input/output end) of each of the optical fibers OF is maintained at a pre-defined distance with respect to a corresponding mirror M. In the illustrated embodiment, a transparent glass, quartz, or sapphire plate cover covers the exposed surfaces on the optical bench OB to protect the mirrors M. In one embodiment, the connector 10 may be filled with index-matching epoxy between the mirror surfaces M and the plate cover.

The foundation 100 provides a demountable connection for an optical connector 10 with matching passive alignment features E1 on its facing mounting surface onto the supporting surface in relation to the PIC chip P. FIG. 4B depicts attaching the optical connector 10 with matching passive alignment features E1 to the passive alignment features E2 on the foundation 100. FIG. 4C depicts after attaching matching passive alignment features E2 of the optical connector 10 to the passive alignment features E2 on the foundation 100, the light path to and from the micromirror array M would pass through the corresponding microlens array L. The passive alignment features E1 and E2 provide accurate optical alignment for this light path, repeatability, and detacheability.

FIG. 1B illustrates a foundation F′ having additional passive alignment features E2′ for passive alignment to the PIC chip P, in accordance with another embodiment of the present invention. In this illustrated embodiment, the foundation 100′ further includes passive alignment features E2′ integrally formed on the bottom surface of the foundation body B2′ that will be facing the PIC chip P. Additional alignment features E2′ on the bottom of the foundation body B2′ allow the foundation body B2′ to be passively aligned to the surface of PIC chip P if there are receptacle and complimentary features on the surface of the PIC chip P. The passive alignment features E2′ may be similar to the features E2 on the top surface of the body foundation B2′.

FIG. 5 illustrates passive aligning a glass foundation 100″ to a PIC chip P, in accordance with another embodiment of the present invention. In this embodiment, the foundation 100″ has in addition passive alignment features E2″ at its bottom surface, and the supporting surface of the PIC chip P has matching passive alignment features E″. They can be used to passively aligned the foundation 100″ to the PIC chip P. Specifically, in this embodiment, the precision alignment features E2″ includes three hemispheres on the bottom of foundation body B2″, which have good position tolerance related to the microlens array L. Complementary precision alignment features including three V-grooves are provided on the top surface of PIC chip P in alignment reference to grating couplers in the PIC chip P. Fiducial marks VF″ may be provided on the top surface of the glass body B2″, which are used to visually align the foundation 100″ to complementay fiducial marks (if provided; not shown) on the PIC chip P to provide first light. The foundation 100″ may be passively aligned and fixedly attached to the supporting surface of the PIC chip P.

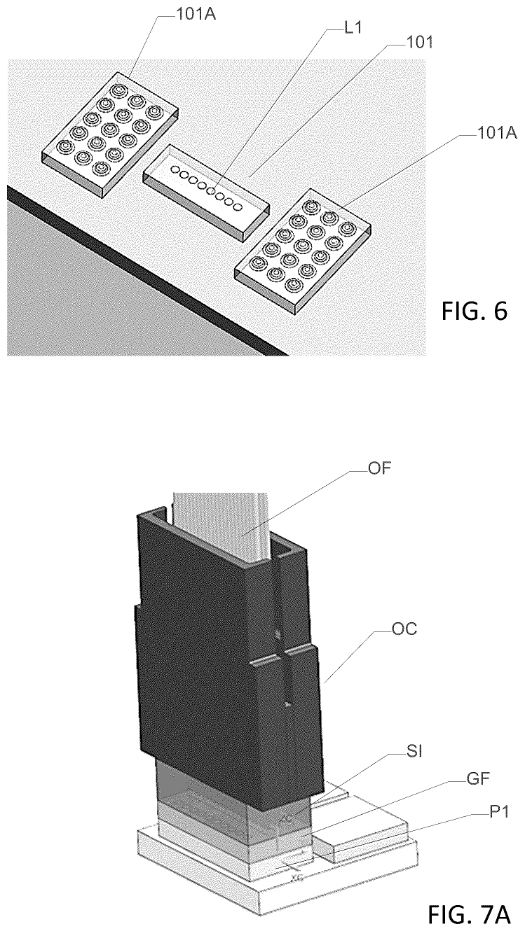

In another embodiment, the foundation 100 may include separate bodies, which are separately provided with passive alignment features and optical element(s). FIG. 6 illustrates a glass foundation 101 comprising one or more separate, disconnected pieces, in accordance with another embodiment of the present invention. In this embodiment, with the alignment foundation 101A and microlens array insert L1 in separate pieces, the alignment foundation 101A could be on the top surface of the PIC chip P or outside the PIC chip P. This configuration is less expensive because it minimizes the area of the functional elements which lowers the cost of the glass molding. However, there are more parts per molding operation.

According to the embodiments discussed above, the foundation 100 (and variations there of) can be aligned to electro-optical elements (e.g., grating couplers, waveguides, etc.) inside or outside the optoelectronic device (see also, further descriptions in connection with FIGS. 4, 5, 9 and 11). The foundation 100 is permanently positioned with respect to the opto-electronic device (e.g., a PIC chip P) to provide an alignment reference to the external optical connector 10. The optical connector 10 can be removably/demountable attached to the foundation F, via a ‘separable’ or ‘demountable’ or ‘detachable’ action that accurately optically aligns the optical connector 10 to the opto-electronic device along a desired optical path. In order to maintain optical alignment for each connect and disconnect and reconnect, this connector needs to be precisely and accurately aligned to the foundation. In accordance with the present invention, the optical connector and foundation are aligned with one another using a passive mechanical alignment (e.g., kinematic, quasi-kinematic, and elastic-averaging alignment), constructed from geometric features on the two bodies. In a specific embodiment, the present invention adopts more specifically mechanical alignment based on elastic-averaging alignment.

In one embodiment, each mirror M is an exposed free surface of the base of the body B1 (i.e., surface exposed to air, or not internal within the body of the base of the optical bench) having an exposed reflective free side facing away from the body B1. The exposed reflective free side comprises a structured reflective surface profile at which light is directed to and from the optical fiber OF and to and from the foundation 100 (including alternate embodiments disclosed herein). Each mirror M bends, reflects and/or reshapes an incident light. Depending on the geometry and shape (e.g., curvature) of the structured reflective surface profile, the mirrors M may collimate, expand, or focus an incident light beam. For example, the structured reflective surface profile may comprise one of the following geometrical shape/profiles: (a) ellipsoidal, (b) off-axis parabolic, or (c) other free-form optical surfaces. For example, the mirror surface, to provide optical power, may have a surface geometrical curvature function of any of the following, individually, or in superposition: ellipsoidal or hyperbolic conic foci, toroidal aspheric surfaces with various number of even or odd aspheric terms, X-Y aspheric curves with various number of even or off terms, Zernike polynomials to various order, and various families of simpler surfaces encompassed by these functions. The surfaces may also be free-form surfaces with no symmetry along any plane or vector. The mirrors M may be defined on the body B1 by stamping a malleable metal material. Various malleable metals, stampable with tool steels or tungsten carbide tools, may compose the body of the minors, including any 300 or 400 series stainless steel, any composition of Kovar, any precipitation or solution hardened metal, and any alloy of Ag, Al, Au, Cu. At the long wavelengths above 1310 nm, aluminum is highly reflective (>98%) and economically shaped by stamping. The reflective surface of the portion of the metal comprising the minor may be any of the metals mentioned above, or any coating of highly reflective metal, applied by sputtering, evaporation, or plating process.

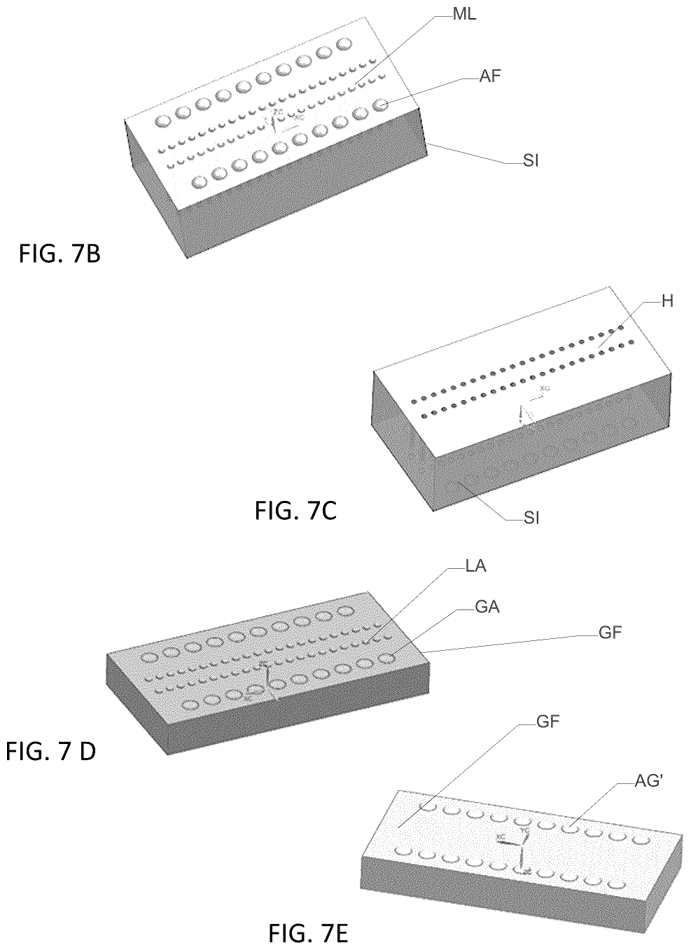

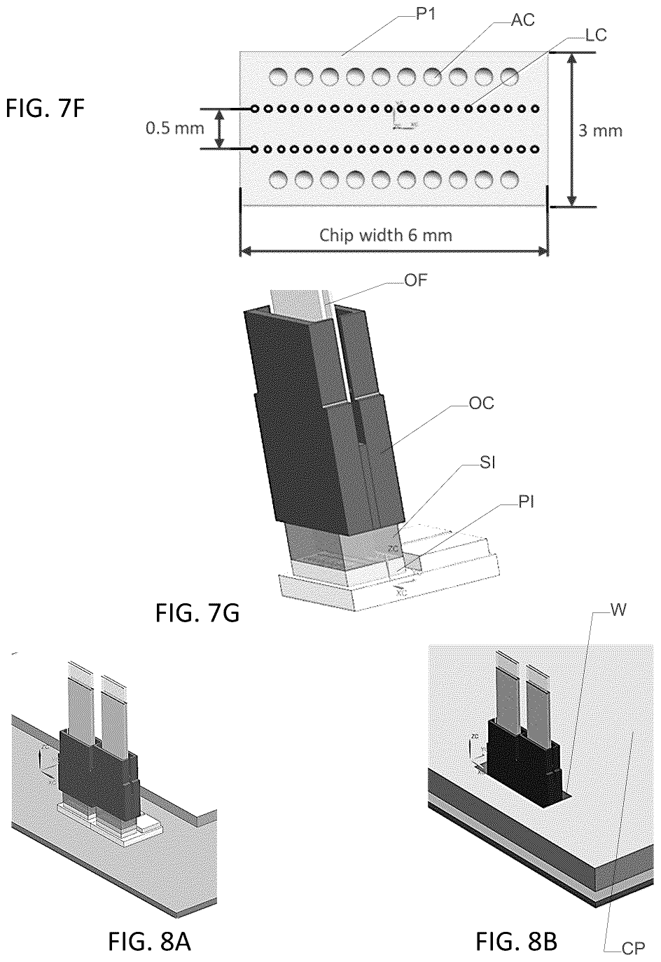

FIGS. 7A to 7F illustrate an implementation of the invention that also provides for expanded-beam optical coupling. FIG. 7A shows the connection of optical fibers OF through an optical connector OC to a photonic integrated circuit (PIC) P1. The PIC, shown in FIG. 7E, has a 2D array of optical I/O ports in which light exits or enters the PIC. A foundation GF, shown in FIG. 7D, includes passive alignment features and a 2D lens array. The foundation GF may be made of silicon or glass. A silicon lens insert SI, shown in FIGS. 7B and 7C, is also attached to the endface of the optical connector OC. This connection is in accordance with another embodiment of the present invention. Passive alignment features on both the silicon lens insert SI and foundation GF assure that the lens arrays on SI and GF are aligned for high coupling efficiency. The lens arrays in the silicon insert SI and foundation GF provide an expanded beam interface. The silicon insert SI can be integrally defined (e.g., by etching) with passive alignment features and an array of optical elements to facilitate direct connection to the top of a PIC device or a grating coupler on a supporting surface.

In FIG. 7B, the male side of the silicon front insert SI has 2×22 channels of microlens ML, which are positionally aligned to the alignment features AF (protrusions) on the silicon insert SI as shown in FIG. 7B. In FIG. 7C, the silicon insert SI has 2×22 channels of an array of blind holes 125.5 μm diameter) from. the hack side, which are aligned with the the microlens array ML shown in FIG. 7B. These blind holes receive the tips of the optical fibers to passively align the silicon insert SI to the array of optical fibers in the optical connector OC, with the side shown in FIG. 7C facing the ends of the optical fibers in the optical connector OC. For the glass foundation GF, FIG. 7D shows 2×22 array of microlenses LA, and a parallel array of alignment features AG that matches against the female alignment features AC on the top of the PIC chip P1 shown in FIG. 7F. FIG. 7E shows the alignment features AG' that complement the alignment features AF on the male side of the silicon insert S1 shown in FIG. 7B. NC chip P1. shown in FIG. 7F. As also shown in FIG. 7F is a 2×22 array of microlenses on the top of the PIC chip P1.

FIG. 7G illustrates implementation of the silicon lens insert SI in an optical connector OC for directly coupling to a PIC chip P1 without use of a glass microlens array shown in FIGS. 7D and 7E. In the embodiment of FIG. 7G, the output of the microlens array ML on the silicon insert is expanded within the PIC, which establishes a pathway for even higher fiber count (e.g., 3 rows or 4 rows).

FIGS. 8A and 8B illustrate alternative application of optical connectors in co-packaged optics. If a window W is provided on the heat-spreading cooling plate CP above the PIC device, this window can be used to design an optical connector body to provide rough alignment to guide the connector body to achieve accurate demountable connection based on the passive alignment features.

In another aspect of the present invention, the foundation could be configured for demountable edge coupling of an optical connector to the waveguides ending at an edge of the optoelectronic device. The foundation may be configured with different optical elements to define the desired beam path with the desired beam shape to maximize optical coupling of optical signals into/out of the optoelectronic device and into/out of the optical connector. For example, the optical beam may be initially expanded between the optical connector and the optoelectronic device and finally focused onto the waveguides on the optoelectronic device and the optical connector. Transmission of the expanded beam requires lower tolerance, with high tolerance maintained at the point of focusing the beam at the target device.

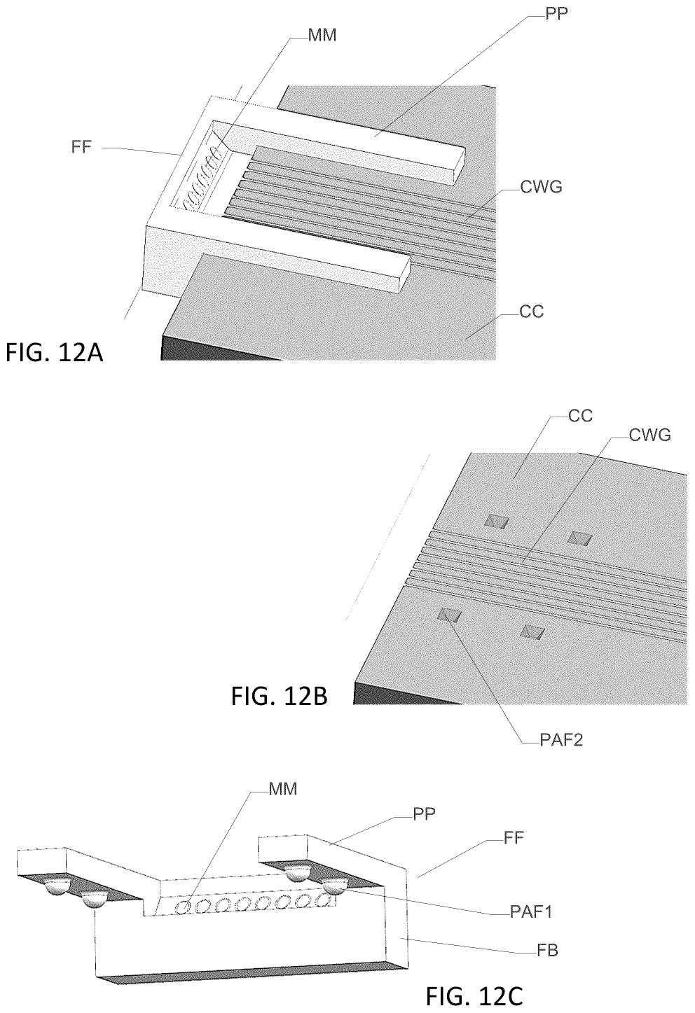

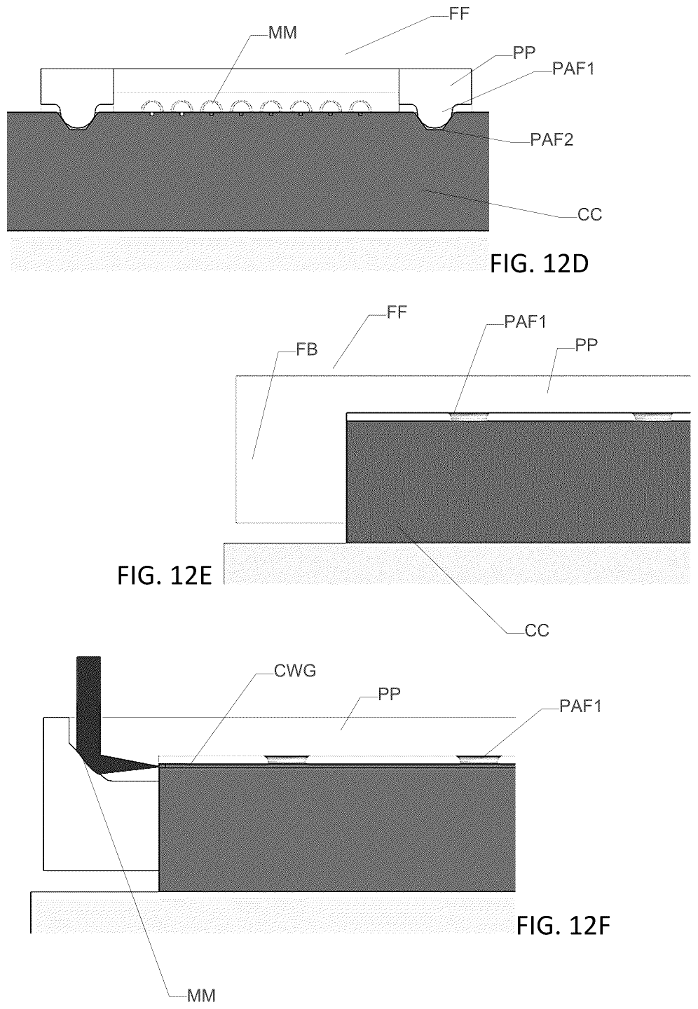

FIGS. 9A and 9D illustrate implementation of a foundation F1 as an edge coupler to a PIC chip C, in accordance with another embodiment of the present invention. In this embodiment, the optical connector OP has an alignment cover plate CV1 that is formed with passive alignment features PA1 facing the foundation F1. The cover plate CV1 is provide with a through opening for the light to pass through along the light path LP1. In this embodiment, and the embodiments in FIGS. 12A-12F, the foundation F1 acts as a glass bridge to direct and reshape the light path LP1. As in the earlier embodiments, the top surface of the foundation F1 is formed with passive alignment features PA2. The foundation F1 can be supported on the support structure SS and the top of PIC chip C, with the support structure SS spaced from the edge of the PIC chip C by a space SP, thus forming a glass bridge structure. In particular, the foundation F1 includes an array of protruded portions or a single connect protruded portion PT1 on the underside facing the PIC chip C, which provides an array of reflective surfaces by total internal reflection (TIR) corresponding to the number of optical fiber OF, number of mirror array M1 and channels in the PIC chip to be coupled. More clearly shown in the enlarged view FIG. 9C, the protrusion PT1 is received in the space SP, so that the protrusion PT1 is below the top surface of the PIC chip C to allow light to be directed to waveguides or other optical elements or components at the top of the PIC chip C. An array of glass waveguide may be provided at the bottom of foundation F1, to guide the light to and from the minor at the protrusion PT1. As were in earlier embodiments, demountable coupling between the optical connector OP and the PIC chip is effected by the passive alignment of the feature PA1 and PA1 between the cover plate CV1 and foundation F1, as depicted in FIG. 9D. Referring back to FIG. 9A, the light path LP1 is an expanded, collimated beam between the mirror M1 and M2, which is focused at the end of the optical fiber OF and the waveguide FWG. Both mirror surfaces M1 and M2 are aspherical mirrors.

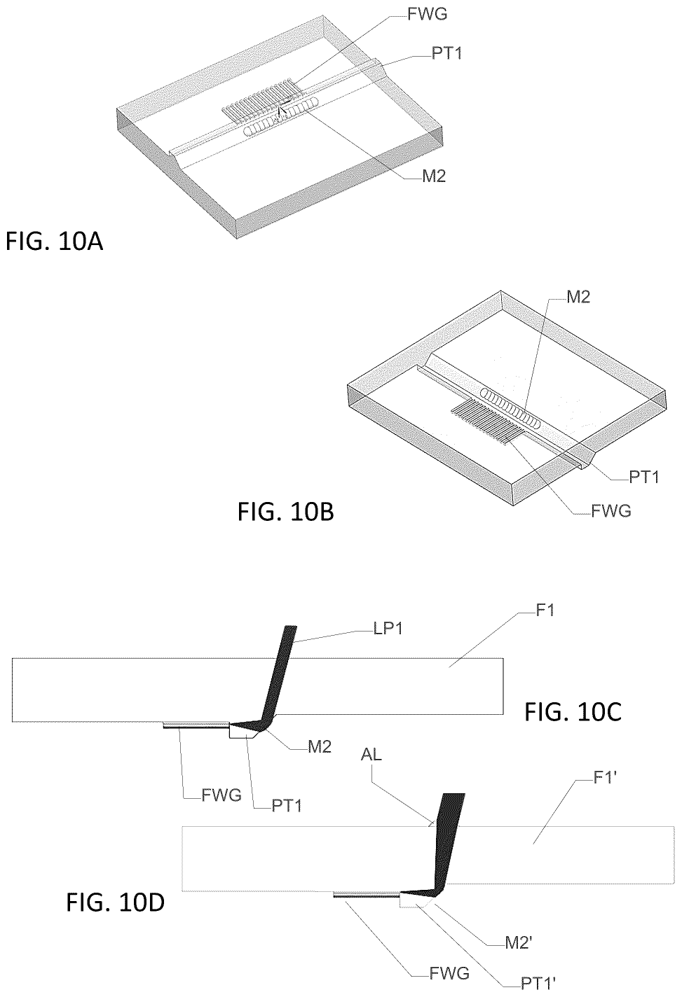

FIGS. 10A and 10B illustrate perspective views of the foundation F1, in accordance with one embodiment of the present invention; FIGS. 10C and FIGS. 10D illustrate different optical elements (e.g., lens, reflective surface) and/or different reflective geometries deployed on the foundation. In FIG. 10C, the reflective surface at the protrusion PT1 is an aspheric minor that bends and collimate incident light (or vice versa depending on the direction of the light travel). between M1 and M2. This is similar to the embodiment shown in FIG. 9C. In FIG. 10D, the mirror M2′ is a flat surface in the protrusion PT1′ of the foundation F1′, which does not collimate incident light. Instead, an aspheric lens AL is provided on the top surface of the foundation F1′, corresponding to the location of the through opening TO in the cover plate CV1, which functions to collimate the light beam between the mirror M2′ and M1. Various optical elements (e.g., lenses) and/or reflective geometries may be used to obtain the desired light beam shape and direction. Further examples are depicted in FIGS. 11A to 11F, illustrating various foundations adopting different optical elements for optical coupling to PIC devices, in accordance with alternate embodiments of the present invention. Some of the components similar to those in the embodiment in FIG. 9 will not be discussed below. The differences are highlighted below.

In the embodiment of FIG. 11A, a pocket is defined at the top of the foundation F2, which receives an optical isolator, which prevents optical power from being reflected back along the optical interconnect and into the laser source, where it will damage the laser. The optical isolator functions as a one-way valve only allowing light to propagate in single direction.

The embodiment of FIG. 11B corresponds to the embodiment of FIG. 10D, in which an aspherical lens is applied to collimate the light since surface of mirror M2′ is a flat reflective surface in the foundation F1′.

In the embodiment of FIG. 11C, the mirror M2 in the foundation F3 is similar to the aspherical mirror M2 in the embodiment in FIG. 9, but the mirror M1′ in the optical connector OP3 is a flat minor. Accordingly, a refocusing lens RL is applied to the top of the foundation F3 at a location corresponding to the through opening TO in the cover plate CV1 to focus the light through the foundation F3 (or to collimate the light going into the foundation F3, dependent on the direction of light travel),

In the embodiment of FIG. 11D, the foundation F1 is similar to the foundation F1 in FIGS. 9 and 10D. However, in this embodiment, an aspherical lens is provided on the underside of the cover plate CV4 (corresponding to the location of the through hole TO in the earlier embodiment) to focus/collimate light along the light path between mirrors M1′ and M2, with mirror M1′ being a flat mirror, and M2 being an aspherical mirror as in earlier embodiments. In this embodiment, the cover plate CV4 does not include a through opening TO for the light beam to pass.

In the embodiment of FIG. 11E, the foundation F5 has a through opening FTO, which defines an exposed aspheric reflective minor surface M5. The mirror M1 in the optical connector OP is an aspherical mirror. The mirror M5 may be metallic coated to improve reflectivity.

In the embodiment of FIG. 11F, the top surface of the PIC chip C′ is provided with a cavity CAV to receive the protruded portion PT6 of the foundation F6. In this embodiment, the reflective surface in the protruded portion PT6 is a flat reflective surface M2′, hence an aspherical lens is provided on the top of the foundation F6, at a location corresponding to the through opening TO in the cover CV1, as was in the case of the embodiment of FIG. 11B.

In all of the above embodiments of foundations having a protruded section at the bottom surface, it is noted that the protrusion is longitudinal in structure, as illustrated in FIGS. 10A and 10B. In the embodiment of FIG. 11F, the cavity CAV is a longitudinal trench at the top surface of the PIC chip C′, in order to accommodate the longitudinal protrusion at the bottom of the foundation F6.

In a further embodiment, a foundation FF is in the form of an interposer for guiding light to/from the exit ends of an array of waveguides at a top or bottom surface of an optoelectronic device (e.g., a PIC chip C). FIGS. 12A to 12F illustrate implementation of a foundation as an edge coupler to a PIC chip having waveguides at its top surface, in accordance with another embodiment of the present invention. In this embodiment, the foundation FF includes an exposed micromirror array MM defined on the body FB′, corresponding to the number of exit ends of waveguides CWG on the top surface of the PIC chip CC, for guiding light from an optical connector (not shown). The foundation FF includes prongs PP on both sides of the array of micromirrors MM, extending from the body FB outwards over the surface of the PIC chip CC. The prongs PP are integrally formed with passive alignment features PAF1 for passive alignment with the passive alignment features PAF2 defined (e.g., etched) on the surface of the PIC chip CC, thereby optically aligning the array of mirrors MM to the array of waveguides CWG. In the illustrated embodiment, the passive alignment features PAF1 are hemispherical protrusions, matching against square openings and tapered bottoms of the passive alignment features PAF2 on the PIC chip CC.

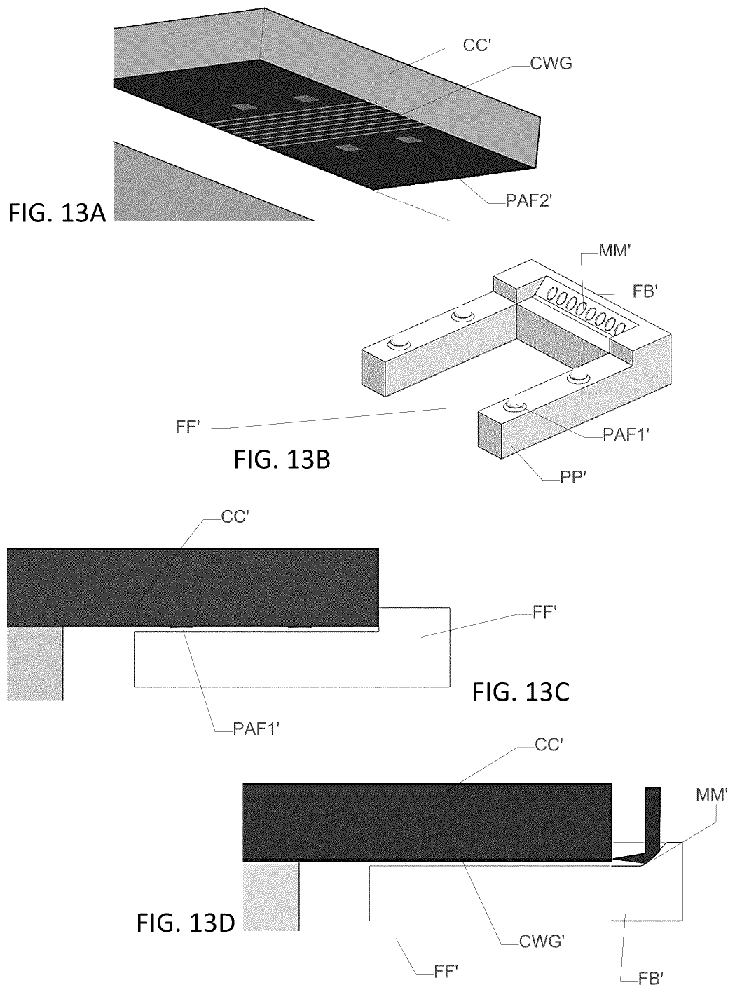

FIGS. 13A to 13D illustrate implementation of a foundation FF′ as an edge coupler to a PIC chip CC′ having waveguides CWG′ at its bottom surface, in accordance with another embodiment of the present invention. The foundation FF′ is similarly structured with prongs PP′ extending from body FB′, having similar passive alignment features PAF1′ matching similar passive alignment features PAF2′ as was in the previous embodiment of FIG. 12. However, given the waveguides CWG′ are at the bottom surface of the micromirrors MM′ are oriented in the same direction away from the passive alignment feature PAF1′ on the upper side of the prongs PP′, in contrast to the previous embodiment of FIG. 12 in which the micromirrors MM are oriented opposite to the extending direction of the hemispherical passive alignment features PAF1.

Instead of using glass for the foundations described in the embodiments above, silicon material may be used instead, for similar benefits as it is optically transparent to infrared light and can be manufactured with dimensional tolerances better than 100 nanometers.

It is noted that FIG. 12E and FIG. 13C are each a side view or a sectional view not taken alone a waveguide CWG/CWG′ or a mirror MM/MM′.

In accordance with the present invention, the optical connector and the foundation define a demountable coupling with an optical element formed on the foundation to provide reshaping and/or redirection of light. Further, the demountable elastic averaging coupling between the optical connector and the foundation is defined without use of any complementary alignment pin and alignment hole.

While the invention has been particularly shown and described with reference to the preferred embodiments, it will be understood by those skilled in the art that various changes in form and detail may be made without departing from the spirit, scope, and teaching of the invention. Accordingly, the disclosed invention is to be considered merely as illustrative and limited in scope only as specified in the appended claims.

We claim:

1. A demountable connection for an optical connector and an optical connection point, comprising:
a foundation provided along the optical path between the optical connector and the optical connection point, supporting the optical connector in optical alignment to the optical connection point, and to facilitate demountable connection of the optical connector to the foundation, wherein the foundation comprises at least one optical element to reshape and/or redirect incident light between the optical connector and the optical connection point, and passive alignment features on a surface of the foundation to provide demountable connection to matching passive alignment feature of the optical connector, wherein position of the optical element is defined relative to the passive alignment features so as to define optical alignment in reference to the passive alignment features and wherein the foundation is attached to the optical connection point.
